(19) United States
(12) Patent Application Publication
(10) Pub. No.: US 2008/0093181 A1
(43) Pub. Date: Apr. 24, 2008

(54) Brake caliper guide pin assembly

(76) Inventors: James R. Waag, Miamisburg, OH (US); David B. Drennen, Bellbrook, OH (US)

Correspondence Address: DELPHI TECHNOLOGIES, INC., M/C 480-410-202, PO BOX 5052, TROY, MI, 48007, US

(21) Appl. No.: 11/784,139

(22) Filed: Apr. 5, 2007

Related U.S. Application Data
(60) Provisional application No. 60/852,764, filed on Oct. 19, 2006.

(51) Int. Cl. F16D 65/14

(52) U.S. Cl. 188/73.45; 188/73.44

(57) ABSTRACT

A brake caliper guide pin assembly including a caliper body defining an elongated bore, the elongated bore defining a central axis, a bushing positioned in the elongated bore, the bushing including at least a first layer and a second layer, wherein the first layer is formed from a rigid material and defines a central opening, and wherein the second layer is formed from a pliable material and is positioned radially outward of the first layer with respect to the central axis, and a guide pin having an elongated stem extending into the elongated bore, wherein at least a portion of the elongated stem is closely received by the central opening.

The present application claims priority from U.S. Provisional Ser. No. 60/852,764 filed on Oct. 19, 2006, the entire contents of which are incorporated herein by reference.

### BACKGROUND

The present application is directed to brake caliper guide pin assemblies and, more particularly, to bushings for brake caliper guide pin assemblies.

Brake caliper assemblies typically include a caliper bracket and a housing. The caliper bracket typically includes an in-board brake pad and an out-board brake pad, wherein the brake pads are positioned about a rotor to clamp the rotor therebetween and apply a braking force to the rotor. The rotor may be associated with a rotating wheel of a vehicle. The housing may include a piston and may be connected to the caliper bracket by guide pins, wherein the guide pins pass though the housing and are received within guide pin bores in the caliper bracket. Therefore, the housing is moveable relative to the caliper bracket in response to movement of the piston, thereby urging both brake pads into engagement with the rotor in response to advancement of the piston.

Preferably, the guide pin assembly would provide low pin sliding forces and reduced rattle noise.

### SUMMARY

In one aspect, the disclosed brake caliper guide pin assembly may include a caliper body defining an elongated bore, the elongated bore defining a central axis, a bushing positioned in the elongated bore, the bushing including at least a first layer and a second layer, wherein the first layer is formed from a rigid material and defines a central opening, and wherein the second layer is formed from a pliable material and is positioned radially outward of the first layer with respect to the central axis, and a guide pin having an elongated stem extending into the elongated bore, wherein at least a portion of the elongated stem is closely received by the central opening.

In another aspect, the disclosed brake caliper guide pin assembly may include a caliper body defining an elongated bore, the elongated bore defining a central axis, a bushing positioned in the elongated bore, the bushing including an inner radial portion and an outer radial portion, the inner radial portion defining a central opening, wherein the inner radial portion is formed from a rigid material and the outer radial portion is formed from a pliable material, and a guide pin having an elongated stem extending into the elongated bore, wherein at least a portion of the elongated stem is closely received by the central opening.

In another aspect, the disclosed brake caliper guide pin assembly may include a caliper body defining an elongated bore, the elongated bore defining a central axis, a bushing positioned in the elongated bore, the bushing including an inner radial portion, a center radial portion and an outer radial portion, the inner radial portion defining a central opening, wherein the inner radial portion is formed from a rigid material, the center radial portion is formed from a pliable material, and the outer radial portion is formed from a rigid material, and a guide pin having an elongated stem extending into the elongated bore, wherein at least a portion of the elongated stem is closely received by the central opening.

Other aspects of the disclosed brake caliper guide pin assembly will become apparent from the following description, the accompanying drawings and the appended claims.

### BRIEF DESCRIPTION OF THE DRAWINGS

FIG. 1 is a front elevational view, partially in section, of one aspect of the disclosed brake caliper guide pin assembly;

FIG. 2 is an end view of the guide pin of the assembly of FIG. 1;

FIG. 3 is a top plan view of the bushing of the assembly of FIG. 1.

FIG. 4 is a front elevational view, partially in section, of a second aspect of the disclosed brake caliper guide pin assembly;

FIG. 5 is a top plan view of the bushing of the assembly of FIG. 4; and

FIG. 6 is a front elevational view, partially in section, of a third aspect of the disclosed brake caliper guide pin assembly.

### DETAILED DESCRIPTION

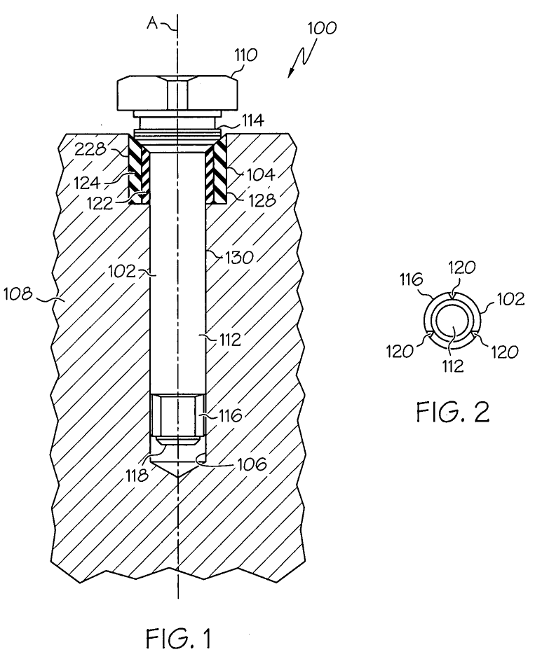

Referring to FIG. 1, one aspect of the disclosed brake caliper guide pin assembly, generally designated 100, may include a guide pin 102, an upper bushing 104 and an elongated bore 106 defined by a caliper body 108, such as a caliper bracket or caliper housing, of a brake caliper assembly. The bore 106 may define a central axis A. The brake caliper assembly may be associated with a rotor (not shown) and may supply a braking force to the rotor.

The guide pin 102 may include a head portion 110, an elongated stem 112 and a flange 114. The flange 114 may be positioned adjacent to the head portion 110 of the pin 102 to restrict the distal portion of the pin 102 from penetrating the bore 106 beyond a predetermined depth. Optionally, a lower bushing 116 may be coaxially disposed over a portion of the stem 112. For example, as shown in FIG. 1, the lower bushing 116 may be disposed over the stem 112 at or adjacent to the distal tip 118 of the stem 112.

The lower bushing 116 may be formed from a material that is biased radially outward to engage the bore 106 when the guide pin 102 is disposed within the bore 106, as shown in FIG. 1. For example, the lower bushing 116 may be formed from rubber, plastic, metal or the like. Referring to FIG. 2, in another aspect, the lower bushing 116 may include one or more channels, slits, passages or notches 120 aligned generally axially with the stem 112 to allow fluid, such as grease or other lubricant, to flow across the lower bushing 116 in the annular region between the stem 112 of the pin 102 and the bore 106.

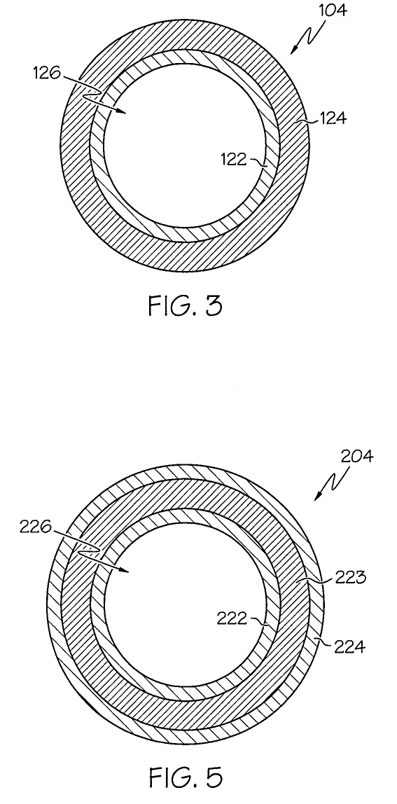

Referring to FIGS. 1 and 3 the upper bushing 104 may be a concentric or radially layered structure and may include an inner radial layer 122 and an outer radial layer 124. The inner radial layer 122 may define a central opening 126 sized and shaped to closely receive the stem 112 of the guide pin 102 therethrough. The inner radial layer 122 may have a radial thickness of about 0.75 mm to about 1.2 mm and may be formed from a rigid material, such as steel, hard plastic or the like. The outer radial layer 124 may have a radial thickness of about 1.25 mm to about 3.0 mm and may be formed from a pliable material, such as natural or synthetic rubber, ethylene propylene diene monomer or the like.

In one aspect, the inner radial layer 122 may be bonded to the outer radial layer 124 by an adhesive. However, those skilled in the art will appreciate that the inner and outer layers 122, 124 may be connected using any available technique, or, alternatively, not physically connected or bonded at all.

The bore 106 may have various geometries and may be formed in the body 108 by any available means, such as drilling, machining, cutting or the like. Referring to FIG. 1, the bore 106 may include a first portion 128 and a second portion 130, wherein the first portion 128 has a larger cross-sectional area than the second portion 130. For example, if the bore 106 is circular in cross-section, then the first portion 128 may have a larger diameter than the second portion. The first portion 128 of the bore 106 may have a cross-sectional profile sized to closely receive the upper bushing 104 therein. The second portion 130 of the bore 106 may have a cross-sectional profile sized to receive the stem 112 of the guide pin 102 therein and permit fluid (e.g., grease) to move through the annular region between the stem 112 and the bore 106.

Those skilled in the art will appreciate that the upper bushing 104 may be inserted into the first portion 128 of the bore 106 by any available means, such as press fitting. In one aspect, the upper bushing 104 may have an axial length of about 6 to about 14 mm.

Thus, the bore 106 may be pre-filled with a lubricant (e.g., grease) such that when the stem 112 of the guide pin 102 is positioned in the bore 106, the rigid inner layer 122 of the upper bushing 104 is closely and coaxially received over a portion of the outer diameter of the stem 112 and the lubricant fills the annular region between stem 112 and the bore 106.

At this point, those skilled in the art will appreciate that the tolerance of the inner layer 122 of the upper bushing 104 may be held tighter than if rubber or some other pliable material was used to form the inner layer 122, thereby allowing for a tighter clearance between the inner layer 122 of the bushing 104 and the outer diameter of the stem 112 and, accordingly, reducing rattle noise. Furthermore, those skilled in the art will appreciate that using an upper bushing 104 allows for a larger clearance between the outer diameter of the stem 112 and the second portion 130 of the bore 106, thereby allowing lubricating fluid to easily fill the annular region therebetween.

Still furthermore, those skilled in the art will appreciate that interference fits and high pin slide forces may be avoided by forming the inner layer 122 of the upper bushing 104 from a rigid, rather than pliable, material. Still furthermore, those skilled in the art will appreciate that the pliable outer layer 124 of the upper bushing 104 may create an interference fit between the bushing 104 and the bore 106, thereby holding the bushing 104 in place. However, those skilled in the art will appreciate that an adhesive may also be used to hold the bushing 104 in place. Still furthermore, those skilled in the art will appreciate that the pliable outer layer 124 of the upper bushing 104 may allow for movement of the pin 102 in the bore 106 while dampening any noise caused by the movement of the pin 102 in the bore 106. Still furthermore, those skilled in the art will appreciate that the pliable outer layer 124 may allow the rigid inner layer 122 to float and self align the pin 102 inside the bore 106 and may reduce the slide force of the assembly 100.

Referring to FIG. 4, another aspect of the disclosed brake caliper guide pin assembly, generally designated 200, may include a guide pin 202, an upper bushing 204 and an elongated bore 206 defined by a caliper body 208 of a brake caliper assembly. The guide pin 202 may include a head portion 210, an elongated stem 212 and a flange 214. The upper bushing 204 may be positioned in a first, larger diameter portion 228 of the bore 206, as described above with respect to assembly 100.

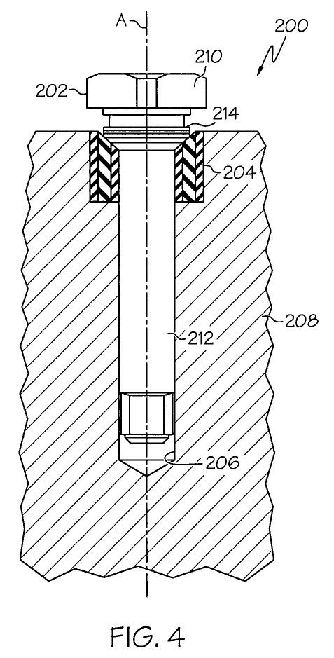

Referring to FIGS. 4 and 5, the upper bushing 204 may be a concentric or radially layered structure and may include an inner radial layer 222, a center radial layer 223 and an outer radial layer 224. The inner radial layer 222 may define a central opening 226 sized and shaped to closely receive the stem 212 of the guide pin 202 therethrough. The inner radial layer 222 may have a radial thickness of about 0.75 mm to about 1.2 mm and may be formed from a rigid material, such as steel, hard plastic or the like. The center radial layer 223 may have a radial thickness of about 1.25 mm to about 3.0 mm and may be formed from a pliable material, such as natural or synthetic rubber, ethylene propylene diene monomer or the like. The outer radial layer 224 may have a radial thickness of about 0.75 mm to about 1.2 mm and may be formed from a rigid material, such as steel, hard plastic or the like. The inner, center and outer radial layers 222, 223, 224 may be bonded together using an adhesive, a heat sealing process or any other available means.

Those skilled in the are will appreciate that the tolerance of the inner layer 222 of the upper bushing 204 may be held tighter than if rubber or some other pliable material was used to form the inner layer 222, thereby allowing for a tighter clearance between the inner layer 222 of the bushing 204 and the outer diameter of the stem 212 and, accordingly, reducing rattle noise.

Furthermore, those skilled in the art will appreciate that the pliable material of the center radial layer 223 may allow for slight movement by undergoing a shear and/or compression, thereby dampening movement and reducing rattle noise.

Still furthermore, those skilled in the art will appreciate that the rigid outer radial layer 224 may provide the ability to press fit or knurl the upper bushing 204 into the larger diameter portion 228 of the bore 206.

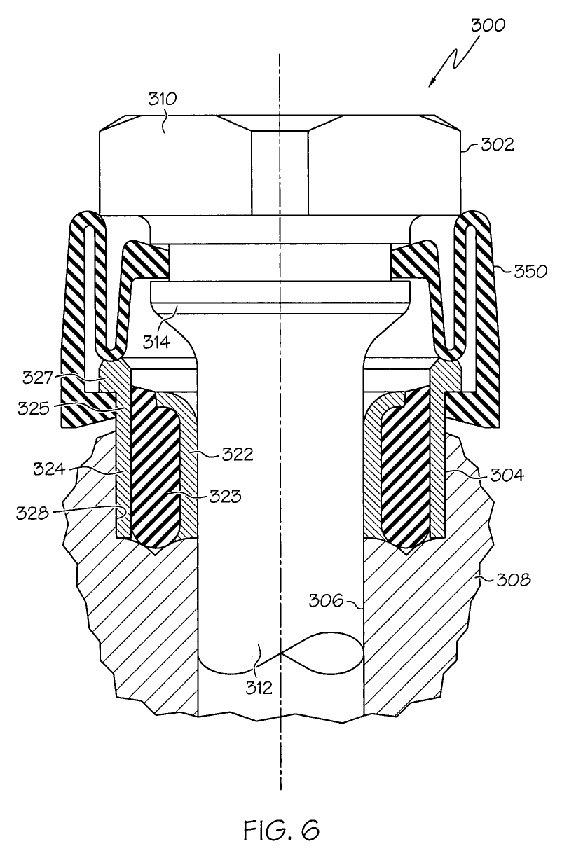

Referring to FIG. 6, another aspect of the disclosed brake caliper guide pin assembly, generally designated 300, may include a guide pin 302, an upper bushing 304, an elongated bore 306 defined by a caliper body 308 of a brake caliper assembly, and an attachment pin 350 adapted to secure the pin 302 to the caliper body 308. The guide pin 302 may include a head portion 310, an elongated stem 312 and a flange 314. The upper bushing 304 may be positioned in a first, larger diameter portion 328 of the bore 306, as described above.

Like the upper bushing 204 of assembly 200, the upper bushing 304 may be a radially layered structure and may include a rigid inner radial layer 322, a pliable center radial layer 323 and a rigid outer radial layer 324. The rigid outer radial layer 324 may include a pin engaging portion 325 that may extend beyond the larger diameter portion 328 of the bore 306. The pin engaging portion 325 of the rigid outer radial layer 324 may include an attachment pin engaging structure 327, such as a flange, a bracket, a tenon or the like, adapted to be engaged by the attachment pin 350.

Accordingly, those skilled in the art will appreciate that providing a attachment pin engaging structure 327 on the upper bushing 304 may eliminate the need for forming (e.g., machining) such structures directly on the caliper body 308, thereby providing an opportunity for cost reduction.

Although various aspects of the disclosed brake caliper guide pin assembly have been shown and described, modifications may occur to those skilled in the art upon reading the specification. The present application includes such modifications and is limited only by the scope of the claims.

What is claimed is:

1. A brake caliper guide pin assembly comprising:
a caliper body defining an elongated bore, said elongated bore defining a central axis;
a bushing positioned in said elongated bore, said bushing including at least a first layer and a second layer, wherein said first layer is formed from a rigid material and defines a central opening, and wherein said second layer is formed from a pliable material and is positioned radially outward of said first layer with respect to said central axis; and
a guide pin having an elongated stem extending into said elongated bore, wherein at least a portion of said elongated stem is closely received by said central opening.

2. The assembly of claim 1 wherein said caliper body is a caliper bracket.

3. The assembly of claim 1 wherein said caliper body includes a surface and said bushing is flush with said surface.

4. The assembly of claim 1 wherein said elongated bore includes a first portion having a first cross-sectional area and a second portion having a second cross-sectional area, wherein said first cross-section area is larger than said second cross-sectional area, and wherein said bushing is positioned in said first portion of said elongated bore.

5. The assembly of claim 1 wherein said rigid material includes at least one of a steel and a hard plastic.

6. The assembly of claim 1 wherein said pliable material includes at least one of a synthetic rubber and a natural rubber.

7. The assembly of claim 1 wherein said first and said second layers are generally aligned with said central axis.

8. The assembly of claim 1 wherein said bushing further includes a third layer formed from a rigid material, wherein said second layer is positioned between said first layer and said third layer.

9. The assembly of claim 1 wherein said elongated bore is generally cylindrical in shape.

10. The assembly of claim 1 wherein said first layer has a radial thickness of about 0.75 to about 1.2 millimeters.

11. The assembly of claim 1 wherein said second layer has a radial thickness of about 1.25 to about 3.0 millimeters.

12. The assembly of claim 1 wherein said bushing has an axial length of about 6 to about 14 millimeters.

13. A brake caliper guide pin assembly comprising:
a caliper body defining an elongated bore, said elongated bore defining a central axis;
a bushing positioned in said elongated bore, said bushing including an inner radial portion and an outer radial portion, said inner radial portion defining a central opening, wherein said inner radial portion is formed from a rigid material and said outer radial portion is formed from a pliable material; and
a guide pin having an elongated stem extending into said elongated bore, wherein at least a portion of said elongated stem is closely received by said central opening.

14. The assembly of claim 13 wherein said rigid material includes at least one of a steel and a hard plastic.

15. The assembly of claim 13 wherein said pliable material includes at least one of a synthetic rubber and a natural rubber.

16. A brake caliper guide pin assembly comprising:
a caliper body defining an elongated bore, said elongated bore defining a central axis;
a bushing positioned in said elongated bore, said bushing including an inner radial portion, a center radial portion and an outer radial portion, said inner radial portion defining a central opening, wherein said inner radial portion is formed from a rigid material, said center radial portion is formed from a pliable material, and said outer radial portion is formed from a rigid material; and
a guide pin having an elongated stem extending into said elongated bore, wherein at least a portion of said elongated stem is closely received by said central opening.

17. The assembly of claim 16 wherein said rigid material includes at least one of a steel and a hard plastic.

18. The assembly of claim 16 wherein said pliable material includes at least one of a synthetic rubber and a natural rubber.

19. The assembly of claim 16 wherein said outer radial portion includes an engaging structure.

20. The assembly of claim 19 further comprising an attachment pin connected to said engaging structure and said guide pin.
